(19) United States
(12) Patent Application Publication
(10) Pub. No.: US 2025/0139624 A1
(43) Pub. Date: May 1, 2025

(54) SYSTEMS AND METHODS FOR A SECURE TOKENIZATION PLATFORM

(71) Applicant: Fidelity Information Services, LLC, Jacksonville, FL (US)

(72) Inventor: Michael COWAN, Jacksonville, FL (US)

(21) Appl. No.: 18/499,098

(22) Filed: Oct. 31, 2023

(51) Int. Cl. G06Q 20/40; G06Q 20/38; H04L 9/32

(52) U.S. Cl. CPC G06Q 20/4014; G06Q 20/382; H04L 9/3213

(57) ABSTRACT

A computer-implemented method for creating and administering a security token representing a resource source. The method includes: receiving as instructions to create a first resource source on a platform; receiving as input, variables related to the first resource source; creating, a set of protocols based on the variables; generating, one or more tokens based on the received variables and protocol; wherein generating the one or more tokens includes: generating and recording a first transaction in a token transaction ledger; and administering a portion of the one or more tokens to a third party, the administering further including: receiving a request for a purchase of a portion of the one or more tokens; verifying payment for the portion of the one or more tokens; minting a set of tokens; transferring the set of tokens to the third party; and destroying the portion of the one or more tokens from the platform.

### TECHNICAL FIELD

The present disclosure relates generally to the techniques and procedures for minting, allocating, and redeeming digital currency and, more particularly, to systems and methods for a secure tokenization platform.

### BACKGROUND

The national size of global private markets is substantial and growing. A private market may refer to financial assets that are not traded on a public exchange. For example, this may include early-stage company equity, venture capital, private equity, hedge funds, and real estates. A key challenge facing private capital market is the lack of liquidity of private markets. Private markets may for example be tied to assets which are not easily sold. Traditional technical solutions for providing a technical asset to represent an investment may fail as they may not allow for certain procedures, such as commitments and capital calls.

Thus, a need exists to improve access to private markets. More particularly, there is a need for a platform capable of providing secure creation and distribution of a more liquid private fund.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to a computer-implemented method for creating and administering a security token representing a resource source, the method including: receiving as input through an application programming interface (API), instructions to create a first resource source on a platform; receiving as input, variables related to the first resource source; creating, a set of protocols based on the variables; generating, one or more tokens based on the received variables and protocol; wherein generating the one or more tokens includes: generating and recording a first transaction in a token transaction ledger; and administering a portion of the one or more tokens to a third party, the administering further including: receiving a request for a purchase of a portion of the one or more tokens; verifying payment for the portion of the one or more tokens; minting a set of tokens, the set of tokens being equivalent in amount to the portion of the one or more tokens requested; transferring the set of tokens to the third party; and destroying the portion of the one or more tokens from the platform, wherein the minting the set of tokens, transferring the set of tokens, and destroying the set of tokens includes recording the minting, transferring, and destroying as a block in the token transaction ledger.

In some aspects, the techniques described herein relate to a method, wherein the variables related to a fund includes a monetary value of the fund, a number of tokens to create, a name of the fund, and a set of terms and conditions for the fund.

In some aspects, the techniques described herein relate to a method, wherein the one or more token includes a single token for each dollar value of the monetary value of the fund.

In some aspects, the techniques described herein relate to a method, wherein the set of protocols define a smart contract and the smart contract defines a set of terms for the monetary fund.

In some aspects, the techniques described herein relate to a method further including transferring accounting records of the one or more tokens to an accounting platform automatically upon the minting, transferring, or destroying of the one or more tokens.

In some aspects, the techniques described herein relate to a method, wherein the amount of the one or more tokens remains the same before and after administering a portion of the one or more tokens to a third party.

In some aspects, the techniques described herein relate to a method, wherein the first transaction includes the variables related to a new monetary fund.

In some aspects, the techniques described herein relate to a method, wherein the first resource source represents a private market fund.

In some aspects, the techniques described herein relate to a method, wherein the one or more tokens includes a commitment variable, wherein the commitment variable corresponds to a legal value owed by the third party of the one or more tokens to the first resource source.

In some aspects, the techniques described herein relate to a method, further including: receiving a notification to generate a request for capital from the third party owners of the one or more tokens; upon receiving verification of a payment associated with the request for capital, initiating a new block in the token transaction ledger to update a value of each of the one or more tokens, to include the payment amount.

In some aspects, the techniques described herein relate to a system for creating and administering a security token representing a resource source, the system including:
a memory having processor-readable instructions stored therein; and
at least one processor configured to access the memory and execute the processor-readable instructions to perform operations including: receiving as input through an application programming interface (API), instructions to create a first resource source on a platform; receiving as input, variables related to the first resource source; creating, a set of protocols based on the variables; generating, one or more tokens based on the received variables and protocol; wherein generating the one or more tokens includes: generating and recording a first transaction in a token transaction ledger; and administering a portion of the one or more tokens to a third party, the administering further including: receiving a request for a purchase of a portion of the one or more tokens; verifying payment for the portion of the one or more tokens; minting a set of tokens, the set of tokens being equivalent in amount to the portion of the one or more tokens requested; transferring the set of tokens to the third party; and destroying the portion of the one or more tokens from the platform, wherein the minting the set of tokens, transferring the set of tokens, and destroying the set of tokens includes recording the minting, transferring, and destroying as a block in the token transaction ledger.

In some aspects, the techniques described herein relate to a system, wherein the variables related to a fund includes a monetary value of the fund, a number of tokens to create, a name of the fund, and a set of terms and conditions for the fund.

In some aspects, the techniques described herein relate to a system wherein the one or more token includes a single token for each dollar value of the monetary value of the fund.

In some aspects, the techniques described herein relate to a system, wherein the set of protocols define a smart contract and the smart contract defines a set of terms for the monetary fund.

In some aspects, the techniques described herein relate to a system, further including transferring accounting records of the one or more tokens to an accounting platform automatically upon the minting, transferring, or destroying of the one or more tokens.

In some aspects, the techniques described herein relate to a system, wherein the amount of the one or more tokens remains the same before and after administering a portion of the one or more tokens to a third party.

In some aspects, the techniques described herein relate to a system, wherein the first transaction includes the variables related to a new monetary fund.

In some aspects, the techniques described herein relate to a system, wherein the one or more tokens includes a commitment variable, wherein the commitment variable corresponds to a legal value owed by the third party of the one or more tokens to the first resource source.

In some aspects, the techniques described herein relate to a system, further including: receiving a notification to generate a request for capital from the third party owners of the one or more tokens; upon receiving verification of a payment associated with the request for capital, initiating a new block in the token transaction ledger to update a value of each of the one or more tokens, to include the payment amount.

In some aspects, the techniques described herein relate to a non-transitory computer readable medium storing processor-readable instructions which, when executed by at least one processor, cause the at least one processor to perform operations including: receiving as input through an application programming interface (API), instructions to create a first resource source on a platform; receiving as input, variables related to the first resource source; creating, a set of protocols based on the variables; generating, one or more tokens based on the received variables and protocol; wherein generating the one or more tokens includes: generating and recording a first transaction in a token transaction ledger; and administering a portion of the one or more tokens to a third party, the administering further including: receiving a request for a purchase of a portion of the one or more tokens; verifying payment for the portion of the one or more tokens; minting a set of tokens, the set of tokens being equivalent in amount to the portion of the one or more tokens requested; transferring the set of tokens to the third party; and destroying the portion of the one or more tokens from the platform, wherein the minting the set of tokens, transferring the set of tokens, and destroying the set of tokens includes recording the minting, transferring, and destroying as a block in the token transaction ledger.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1 is a schematic block diagram of an exemplary electronic transaction system, according to one aspect of the present disclosure.

FIG. 2 depicts an exemplary flowchart of the creation and allocation of a digital asset, according to one aspect of the present disclosure.

FIG. 3 depicts an exemplary flowchart of the allocation and redemption of a digital asset, according to one aspect of the present disclosure.

FIG. 4 depicts an exemplary flowchart of the minting, allocation, and redemption of a digital asset, according to one aspect of the present disclosure.

FIG. 5 depicts an exemplary flowchart of a method for creating and administering a security token representing a resource source, according to one aspect of the present disclosure.

FIG. 6 illustrates a computer system for executing the techniques described herein, according to one or more embodiments of the present disclosure.

### DETAILED DESCRIPTION OF EMBODIMENTS

The present disclosure relates generally the techniques and procedures for minting, allocating, and redeeming digital currency, and, more particularly, to systems and methods for a secure tokenization platform. For example, one or more embodiments may describe systems and methods for a tokenization platform. The tokenization platform may allow for a user (e.g., a general partner or limited partner) to upload a first resource (e.g., a private market fund). The tokenization platform may be configured to generate a smart contract and mint tokens for the first resource. The tokenization platform may be configured to allocate tokens, mint and redeem tokens, perform capital calls, update valuations of a digital token, and include commitment obligations within the tokens of the tokenization platform. The tokenization platform may for example, record the minting, transferring, and destroying of tokens within a block of a block chain.

The subject matter of the present disclosure will now be described more fully with reference to the accompanying drawings that show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

A key challenge facing private capital market practitioner's globally is the lack of liquidity and the overexposure of institutional investors. For examples, many assets such as early-stage company equity, venture capital, private equity, hedge funds, and real estates may have limited opportunities or times of year for an investor to purchase of sell ownership stakes of a private fund. Further, certain private funds may require particular monetary investments in order to purchase an ownership stake in a private fund. This may lead to only institutional investors participating in private funds.

One or more embodiments may include systems and methods may allow for the fractionalizing and tokenization of all assets including private capital market environments. The system may be a comprehensive, scalable, and cost-effective platform for tokenization of assets such as private markets. Tokenization may refer to the process of converting real-world assets into digital tokens that can be stored, traded, and transferred on the blockchain. A token (e.g., a digital token) may refer to the representation of value or rights that is recorded in a blockchain. The platform may provide new and existing general partners with the ability to tokenize private equity funds creating liquidity for limited partners to buy and sell the created tokens. Further, the system described herein may seamlessly interconnect with additional platforms, allowing for the onboarding of new investors and providing safe custody and redemption of the tokens. The system described herein may for example provide new inventors with access to private markets.

One or more embodiments may include systems and methods for creating, storing, and allocating a digital token representing a resources source, where a resource source may refer to a monetary fund. The system and methods may for example comply with risk, regulation, compliance as well as token standards such as the ERC-3643 standard.

One or more embodiments may include systems and methods that may allow for a user (e.g., an individual or company) to tokenize private equity funds. By tokenizing the private equity fund, this may allow for liquidity of the private equity funds. The system may allow for the tokenization of the fund itself, rather than creating tokens of the individual monetary assets within the fund. The system may allow for incorporating of private capital markets, technical solutions, blockchain, and digital assets as well as venture development and execution.

One or more embodiments may include a system that includes components for the automatic generation of a digital asset and the minting of one or more digital tokens. One or more components of the system may for example receive a series of variables (e.g., a fund identifier, terms and triggers of a fund, compliance rules of a fund, ownership of the fund, capital invested, and/or value of the fund) and automatically communicate with a component to mint and allocate digital tokens.

In one embodiment, a tokenization platform may include a portal that receives a request to generate a fund. The request may include the series of variables such as a fund identifier, terms and triggers of a fund, compliance rules of a fund, ownership of the fund, capital invested, and/or value of the fund. The tokenization platform may then transmit a request to a transfer agent service to facilitate the creation of the rules that define a token, to establish ownership of the token, to provide initial distribution of tokens, and to assign value to the tokens. The transfer agent service may then send a request to the tokenization platform to create the token and generate a token. This may include generating a smart contract and transmitting the smart contract to a block chain. The transaction and generation of the platform may for example be recorded in a private blockchain.

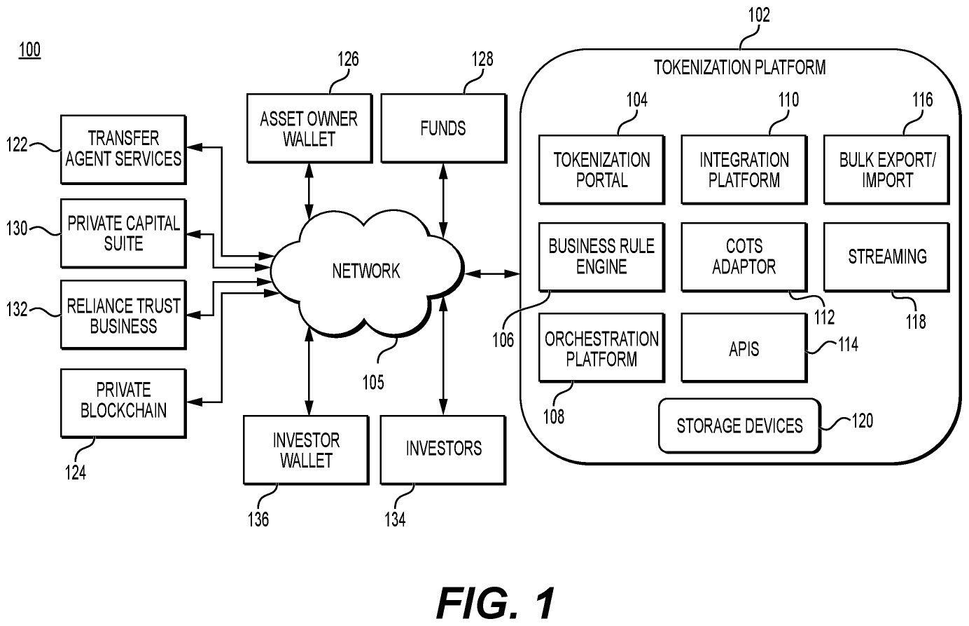

FIG. 1 is a schematic block diagram of an exemplary electronic transaction system, according to one aspect of the present disclosure. The system 100 may include a tokenization platform 102 configured to communicate with one or more modules (e.g., transfer agent services 122, a private blockchain 124, an asset owner wallet 126, a private capital suite 130, a reliance trust business 132, investors 134, and an investor wallet 136) through a network 105.

The communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular communication network and may employ various technologies including 5G (5th Generation), 4G, 3G, 2G, Long Term Evolution (LTE), wireless fidelity (Wi-Fi), Bluetooth®, Internet Protocol (IP) data casting, satellite, mobile ad-hoc network (MANET), vehicle controller area network (CAN bus), and the like, or any combination thereof. The network may be a secured network that is private and protected by a firewall and limited external access.

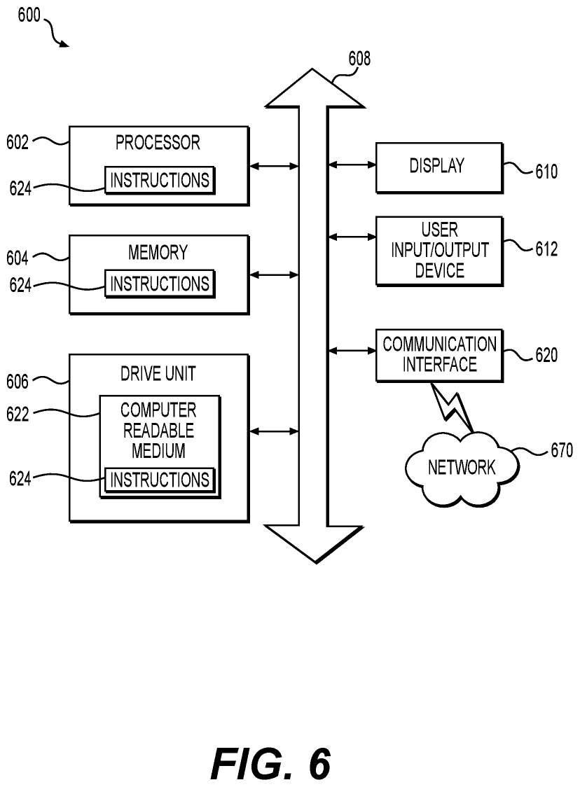

The tokenization platform 102 may comprise a computer system consistent with or similar to that depicted in FIG. 6. The tokenization platform 102 may be a platform with multiple interconnected components such as a tokenization portal 104, a business rule engine 106, an orchestration platform 108, an integration platform 110, a Commercial-Off-The-Shelf (COTS) Adaptor APIs 114, a bulk export/import 116, streaming 118, and one or more storage devices 120. The tokenization platform 102 may include one or more servers, intelligent networking devices, computing devices, components, and corresponding software for enabling users to convert private capital market assets into digitalized tokens, and to mint, allocate, and redeem tokens. The tokenization platform 102 may be configured to create a contract that represents an asset on the blockchain, wherein the smart contract defines the ownership and transfer rights of the token.

The tokenization platform 102 may for example include the capabilities of a transfer agency. This may allow for the tokenization platform 102 to manage and change the ownership of assets (e.g., digital tokens) within the platform.

The tokenization platform 102 may be configured to mint, allocate, and redeem tokens for multiple resource sources (e.g., can be used to assign different tokens for different funds).

The tokenization platform 102 may include a tokenization portal 104. The tokenization portal 104 may have three functions: (1) providing tools to generate one or more digital tokens for an asset; (2) providing purchase and redemption of previously created digital tokens; (3) providing a user interface (UI) that displays an individual's assets as well as their to date performance and information related to the particular tokens. The tokenization portal 104 may include a user interface that allows a user to access the tokenization platform 102 to create tokens (e.g., mint tokens), allocate a token (e.g., sell a token), and or purchase tokens.

The tokenization portal 104 may provide a user (e.g., a money fund manager or a general partner) have the ability to create a new token for a new asset (e.g., for a new private market fund). For example, the tokenization portal 104 may be configured to receive as input the investment term of the asset, how many tokens to produce, the valuation of the asset, and/or a payoff value associated with a resource source. The tokenization portal 104 may include an application programming interface for receiving the instructions to create a first resource (e.g., a fund). Further, additional information related to the asset resource source be input (e.g., fees and expenses, investment objectives, investment strategies, risks, performance, pricing, and more). Further, the tokenization portal 104 may be configured to receive files that include the investment term of the asset, how many tokens to produce, the valuation of the asset, and/or a payoff value.

The tokenization portal 104 may further include a UI that a user (e.g., investors) may access to purchase and sell tokens. The tokenization portal 104 may utilize APIs 114 to enable the display of graphics primitives such as icons, menus, buttons, data entry fields, etc. For example, as will be discussed below, the tokenization portal may interact with the reliance trust business 132 to allow for the purchase and redemption of tokens. The tokenization portal 104 UI may include a display of a user displaying any token that a user owns on the tokenization platform 102. The user may have access to purchase additional tokens through the tokenization portal 104. Users may further have access to sell tokens through the tokenization portal 104. A user may access information related to tokens that they own or wish to purchase such as the fund name/identifier, terms and triggers, compliance rules that apply to the token, ownership of the token, invested value, and value of the tokens.

The tokenization platform 102 may include a business rule engine 106. The business rule engine 106 may be responsible for configuring a smart contract. The business rule engine 106 may for example receive all variables related to a fund. The variables may include, but are not limited to a fund identifier, terms and triggers of a fund, compliance rules of a fund, ownership of the token, capital invested, and/or value of the token. The variables may be transferred to the business rule engine 106 from an external platform (e.g., the private capital suite 130), or from the tokenization portal 104 . . . . Upon receiving the variables, the business rule engine 106 may be configured to prepare a smart contract. This may incorporate the business rule engine 106 accessing a blockchain (e.g., the private blockchain 124) and writing the smart contract, compiling the code, and deploying the contract to the blockchain. The smart contract may for example define the rules and condition for the issuance, transfer, and use of a digital token.

The tokenization platform 102 may include an orchestration platform 108. The orchestration platform 108 may for example provide various integration layers and provide a workflow between the business rule engine 106 and the tokenization portal 104. The orchestration platform 108 may contain the internal rules and workflows of the tokenization platform 102.

The tokenization platform 102 may include an integration platform 110. The integration platform 110 may be configured to write a block in the private blockchain 124. For example, the integration platform 110 may be first gather the initial data (e.g., the fund identifier, terms and triggers of a fund, compliance rules of a fund, ownership of the token, capital invested, and/or value of the token) or gather any transaction data (e.g., allocations, minting, or redemption). The integration platform 110 may then validate the initial token data or transaction data. The integration platform 110 may create a block header (e.g., by interacting with the private blockchain 124). The block header may include the block version, a previous block hash, the merkle root hash, the timestamp and the nonce. The merkle root hash may be a cryptographic hash of all of the transaction hashes in the block. The integration platform 110 may calculate the nonce, where the nonce is a random number that is utilized to mine the block. Next, the integration platform may broadcast the block to the network to be mined. After the block has been mined, the block may be validated. If the block is valid, the integration platform 110 may be added to the block of the private blockchain 124.

The integration platform 110 may assist with interconnection of the COTS Adaptors 112, the APIs 114, the bulk export/import 116, and streaming 118 with the tokenization portal 104 and the business rule engine 106.

The tokenization platform 102 may include a COTS adaptor 112. The COTs adaptor 112 may for example include APIs for the tokenization platform 102 to interact with and transfer tokens between additional digital marketplaces, exchanges, and/or decentralized finance lending platforms.

The tokenization platform 102 may include application programming interface (API) server 114. The API server 114 may include various APIs that the tokenization platform 102 utilizes to facilitate communication within itself and to facilitate the minting, storing, and allocation of digital tokens. The APIs may further facilitate communication between the tokenization platform 102 and other components (e.g., transfer agent services 122, a private blockchain 124, an asset owner wallet 126, a private capital suite 130, a reliance trust business 132, investors 134, and an investor wallet 136).

The tokenization platform 102 may include a bulk export/import server 116. The bulk export/import server 116 may for example export and import data from the tokenization platform 102 to connected (e.g., by network 105) servers and processors. For example, the bulk export/import server 116 may assist with transfer electronic records to a private capital suite 130.

The tokenization platform 102 may include a streaming server 118. The streaming server 118 may for example receive market data via exchanges, market data providers, and/or data feeds. The streaming server 118 may further process the data received and deliver the data in particular formats to various other servers within the tokenization platform 102.

The tokenization platform 102 may include one or more storage devices 120. Each of the modules, processors, and or servers within the tokenization platform 102 may have access to the one or more storage devices 120. The one or more storage devices 120 may for example include copies of the distributed ledger (e.g., the private blockchain 124).

The tokenization platform 102 may for example interact with a transfer agent services 122 through network 105. The transfer agent services 122 may for example receive a notification from the tokenization portal that a new fund has been generated. Upon receiving the notification, the transfer agent service 122 may receive the variables input with the generated fund (e.g., the fund name/identifier, terms and triggers, compliance rules that apply to the token, ownership of the token, invested value, and/or value of the tokens). Upon receiving the new fund request, the transfer agent service 122 may establish asset ownership. This may include assign ownership to entities (e.g., investors 134) and assigning amount of tokens ownership of the particular tokens. The asset ownership may for example have been entered by the initial creator of the fund and input in the tokenization portal 104. In another example, the transfer agent service 122 may include a UI that may receive as input ownership information.

The transfer agent service 122 may further me configured to provide valuation of the tokens. For example, the transfer agent service 122 may receive as input the total value assigned to a created set of tokens. The transfer agent service 122 may then assign value to the set of tokens based on the overall value of the tokens and the amount of tokens created. This assigned value of the token may be assigned to the token as the initial value. This information may transfer to the tokenization platform 102 (e.g., to the digital storage devices 120). The transfer agent service 122 may obtain the valuation from either the tokenization portal 104 or as input from for example a user (e.g., from the institution or general partner creating the fund).

The transfer agent service 122 may then be configured to, upon establishing asset ownership of tokens and providing valuation of the token, transmit this information back to the tokenization platform 102. This information may for example be provided to the integration platform 110 automatically (e.g., by the orchestration platform 108) to prepare record the token ownership in a blockchain.

The transfer agent service 122 may further be utilized during the capital call as well as the period/event valuation of tokens stored on the tokenization platform 102. Capital call may refer to a demand for capital from investors in a private equity or venture capital. The period/event valuation may refer to a process of estimating the value of a particular fund at a specific point in time or in response to a specific event. When either event occurs, the value of a fund and any corresponding token may thus be altered. The transfer agent service 122 may be configured to transfer updated value of a fund and the corresponding tokens to the tokenization platform 102 and the private blockchain 124. For example, an owner of a private fund (e.g., the funds 128) may for example perform a period/event valuation of a fund that is tokenized by the tokenization platform 102. The new value may be transferred to the transfer agent service 122. The transfer agent service 122 may for example transfer this information to the integration platform 110 automatically (e.g., by the orchestration platform 108) to prepare a new blocks in the private blockchain 124 updating the value of the respective tokens.

The system 100 may include a private blockchain 124 (e.g., a private blockchain ledger that includes one or more blockchains) that is a distributed database that is shared among the nodes of a computer network. The blockchain 124 may for example store the generation, allocation, redemption, and destruction of the tokens for a fund. The blockchain may further include the fund identifier, terms and triggers of a fund, compliance rules of a fund, ownership of the token, capital invested, and/or value of the token for each token recorded.

The private blockchain 124 may for example be a private blockchain. In another example, the private blockchain 124 may be a public blockchain or a point-to-point distributed (or shared) ledger. The private blockchain 124 may comprise a secure public, semi-public, or private ledger. In the private blockchain information about a sequence of transactions may be stored in a public, semi-public, private, or point-to-point database, or “chain,” of transactions. Each transaction may be represented in a “block” of information that includes information about a minting, allocation, or redemption of a digital asset. The information may include for example an identifier (e.g., a name or ID associated with a particular fund), terms and triggers (e.g., the vesting period associated with a fund), compliance rules that apply with the token, ownership, capital invested, and the value of the token.

One feature of the private blockchain 124 is that the transactions may be verified and then stored in a block that is given a timestamp and a unique identifier or “hash.” The combination of the verification and the unique hash for a block ensures that falsified transactions cannot be entered into the private blockchain 124, and the recorded transactions are immutable. That is, a transaction, once recorded, cannot be deleted or altered without detection. The sequence of transactions, likewise, cannot be altered without detection.

The private blockchain 124 may be distributed in a peer-to-peer network, such that identical copies of the distributed ledger are stored on the computing resources of multiple peers in the network. Thus, any attempt to alter a block on one peer may be easily detected by comparison with unaltered copies of the shared ledger on other peers. In some embodiments, computing resources and electronic storage present in the tokenization platform 102, may operate as a peer in the peer-to-peer network supporting the private blockchain 124, with the peer possibly storing a separate copy of the blockchain.

The system may for example include asset owner wallets 126 and investor wallet 136. The asset owner wallet 126 and investor wallet 136 may both refer to either a software program or hardware device that stores keys and facilitating the receiving and transfer of digital tokens. The asset owner wallet 126 and investor wallet 136 in particular may have access to the digital tokens created by the tokenization platform 102 and stored in the private blockchain 124. The asset owner wallet 136 may be the asset of investors 134. The asset owner wallet 126 may refer to the wallet by a creator of a fund 128 (e.g., the wallet of general partners of limited partners). The asset owner wallet 126 may initially have 100% of all tokens for a newly generated fund prior to allocation of the tokens.

The system 100 may further include a private capital suite 130. The private capital suite 130 may refer to an accounting software program and hardware devices responsible for tracking the ownership stake of particular digital funds and/or assets. The tokenization platform 102, may for example, upon the generation of a new fund, or any update of the private blockchain 124, automatically generate a notification to update the private capital suite 130. As tokens are created, allocated, changed in value, and destroyed within the tokenization platform 102, the private capital suite 130 may receive notifications automatically.

The system 100 may further include a reliance trust business 132. The reliance trust business 132 may refer to the hardware and software interface utilized by investors to purchase and redeem tokens from the tokenization platform 102. The reliance trust business 132 may for example include an interface for investors 134 to purchase or sell tokens on the tokenization platform 102. The reliance trust business 132 may for example interact directly with the tokenization portal 104 to perform these purchases and sales. The tokenization portal 104 may be responsible for performing the updated transactions.

The system 100 may for example be utilized by investors 134 to purchase the tokens through the investor wallet 136 of the tokenization platform 102. Investors 134 may refer to any individual or entity that purchases an ownership stake (e.g., a digital token) in a fund of the tokenization platform 102. The investors may for example be limited partner or smaller parties that do not have traditional access to private markets.

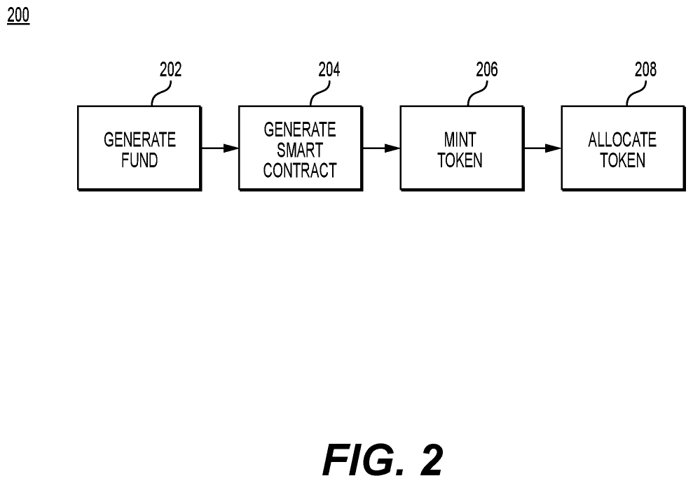

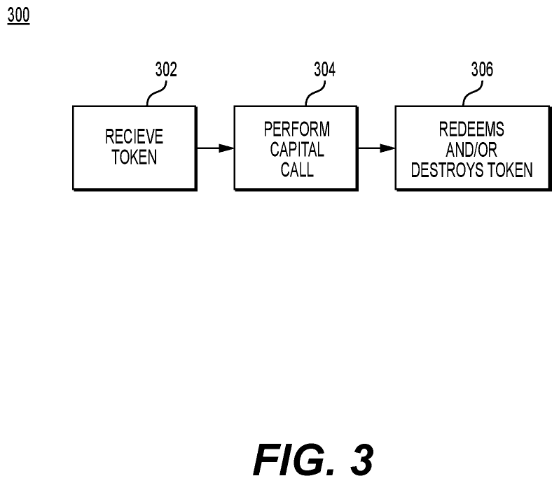

FIG. 2 below may depict the process of generating a new fund (e.g., a resource source), creating a smart contract, minting tokens and allocating tokens utilizing the system 100. FIG. 3 may depict the process of purchasing tokens, performing capital calls, and performing token redemption utilizing system 100. The process of FIG. 3 may for example take place after the process of FIG. 2.

FIG. 2 depicts an exemplary flowchart of the creation and allocation of a digital asset, according to one aspect of the present disclosure. The flowchart 200 may depict an exemplary method of a user developing digital assets to represent the value of a resource source. Exemplary process flows of the method 200, performed in accordance with the system 100 above, are described hereinafter.

At step 202, a new resource source may be generated. Resource source may refer to a private fund. For example, prior to inputting the information into the system 100, a general partner may create a new private equity fund. This may include onboarding limited partner and general partners in the creation of the fund. The creators of the fund may perform initial due diligence and verify the identity of potential customers to asses their risk profiles. A fund may first be initially created through the tokenization platform 102 (e.g., by the tokenization portal).

A user may for example generate a fund within the tokenization platform 102. For example, a user may utilize the tokenization portal 104 to initiate creation of a digital asset for a fund. Upon completing initial creation of a digital asset for a fund, the fund may be structured and further set up the fund within the transfer agent services 122. For example, a user may input the fund name/identifier, terms and triggers, compliance rules that apply to the token, ownership of the token, invested value, and/or value of the tokens into either the tokenization portal 104 (which may then transfer the data to the transfer agent services 122) or directly to the transfer agent services 122. This may occur automatically upon the initial creation of a new fund in the tokenization platform 102. Further, additional information such as the rules and condition for the issuance, transfer, and use of the digital token meant to represent the token may be recorded in the tokenization platform 102 and transferred to the private capital suite 130. Additionally, any required commitments for a fund may be input as a variable.

Generating the fund may further include, utilizing the variables (e.g., the fund name/identifier, terms and triggers, compliance rules that apply to the token, ownership of the token, invested value, and/or value of the tokens) to establish ownership of the tokens and to provide valuation of the tokens (e.g., by the transfer agent services 122). This information may then be transferred back to the tokenization platform 102 to assist with the creation of the smart the contract and the minting of the tokens.

At step 204, a smart contract may be created for the fund from step 202 and the corresponding tokens that will be created. For example, the smart contract may be created by the business rule engine 106. The business rule engine 106 may for example pull certain information regarding the new fund of step 202 to create the smart contract. For example, information such as the rules and condition for the issuance, transfer, and use of a digital token may be received by the business rule engine 106. This may be extracted from digital storage 120 or from the private capital suite 130, or transferred from the transfer agent services 122. The smart contract may be created automatically upon completion of step 202. For example, upon receiving the valuation and ownership from the tokens, along with the fund information (e.g., the information such as the rules and condition for the issuance, transfer, and use of a digital token), a smart contract may be created for a particular fund. The smart contract may be a self-executing contract that is stored on the block chain. It may store the rules of the created tokens such as supply, utility, and transferability. Lastly, the smart contract may be deployed to a blockchain. For example, the smart contract may be deployed to a newly created block chain or to an existing block chain such as Ethereum. Deployment may include: (1) compiling the smart contract into bytecode; (2) transferring the bytecode to the blockchain (e.g., the private blockchain 124); (3) paying a gas fee to miners to execute the contract and deploy the smart contract to the blockchain (e.g., the private blockchain 124); (4) obtaining confirmation that the transaction has transfer to the blockchain and received by miners; and (5) receiving the smart contract address which may be a unique identifier that may be utilized to interact with the contract.

At step 206, the tokenization platform 102 may generate one or more tokens. Generating new tokens may be referred to as minting. The smart contract from step 204 may include a function for minting new tokens. Minting may include assigning the tokens to the initial token holder. For example, the issuer that creates the tokens may receive all of the initial token (e.g., the general partner may receive 100% of the token initially). Alternatively, the issuer may assign tokens based on particular investments (for example by an investor such as a limited partner). This step may include setting the token supply (i.e., the total number of tokens to create) and assigning the previously determined value of each token. This information may be extracted from the smart contract. The initial generation of tokens may be written into the blockchain that includes the smart contract from step 204 (e.g., the private blockchain 124).

Generating the token may include utilizing the tokenization platform (e.g., the integration platform 110) to write a block in the private blockchain 124. For example, the following steps may be performed to generate tokens in the private blockchain 124: the integration platform 110 may first gather the initial ownership information and amount of tokens to generate. The integration platform 110 may then validate the initial token data or transaction data. The integration platform 110 may create a block header. The block header may include the block version, a previous block hash (e.g., the same as the smart contracts), the merkle root hash, the timestamp and the nonce. The merkle root hash may be a cryptographic hash of all of the transaction hashes in the block. The integration platform may calculate the nonce, where the nonce is a random number that is utilized to mine the block. Next, the integration platform may broadcast the block to the network to be mined. After the block has been mined, the block may be validated. If the block is valid, the integration platform 110 may be added to the block of the private blockchain 124.

After the token is minted, owners of the token may for example view the ownership through the tokenization portal 104. The tokenization portal 104 may for example connect to an asset owner wallet 126 or an investor wallet 136. The wallets may for example store the public and private keys associated with the private blockchain 124. The tokenization portal 104 may include a UI that displays the amount and value of a particular token.

At step 208, a user may for example allocate a token. For example, tokens may be allocated to limited partners or investor's wallets as they commit to the fund from step 202. For example, a user may access the tokenization portal 104 to commit to a fund. This may for example be initiated separately through the reliance trust business 132. Upon receiving an investment, the tokenization platform 102 began preparing a new block in the blockchain to facilitate the allocation.

For example, administering one or more tokens of a generated set of tokens to a third party may first include receiving a request to purchase one or more tokens (e.g., by the reliance trust business 132). The reliance trust business 132 may then verify that payment is received prior to initiating the allocation. Upon receiving verification, the tokenization platform may proceed with: (1) minting a set of tokens, the set of tokens being equivalent in amount to the portion of one or more tokens requested; (2) transferring the set of tokens to the investor; and (3) destroying the portion of the one or more tokens from the platform. This process of minting, transferring, and destroying may for example be recorded in a single block in the private blockchain 124. This may be performed by creating a block in a blockchain as described above.

Upon the allocation, the initial owner's wallets (e.g., the asset owner wallet 126 such as a general partner who sells/allocates a token) and the investors wallet (e.g., the investor wallet 136 of the investor who may for example purchase the assets) may be updated.

It may be noted that the investor may purchase whole numbers of tokens or fractions of tokens (e.g., a half of a token, 0.235 tokens, or a dollar value amount that translates to a factional number of tokens).

It may be noted that investors may utilized the tokenization platform 102 to purchase and sell multiple different tokens that may all be distributed through the tokenization platform 102.

FIG. 3 depicts an exemplary flowchart of the allocation and redemption of a digital asset, according to one aspect of the present disclosure. The flowchart 300 may depict an exemplary method of a user purchasing and redeeming digital assets that represent the value of a resource source. Exemplary process flows of the method 300, performed in accordance with the system 100 above, are described hereinafter.

At step 302, an investor may for example receive a digital token through the tokenization platform 102. The investor may for example receive the digital token using the techniques described in step 208 of FIG. 2.

At step 304, a capital call may be initiated for a private fund associated with the token acquired at step 302. The capital call may, through the tokenization platform 102, request capital (e.g., monetary investment) from the owners of the token associated with the private fund. Upon payment of the capital call by an investor 134 who owns one or more tokens, the value of the tokens may be increased by the amount of the capital call. For example, a new block in the blockchain may be generated for each capital call. The new block may record the update in a token's value (e.g. an update in dollar value).

During step 304, the funds may automatically be pulled (e.g., through the reliance trust business 132) upon a capital call. In another example, a request may be sent to the investor (e.g., an owner of a digital token) to provide a capital call. The capital call may require that an investor contribute to the capital call based on the percentage of the tokens that the investor owns. For example, if an investor owns ten tokens and there are one hundred tokens, and the tokenization platform initiates a capital call for one million dollars total, then each of the tokens may increase in value by $10,000 upon completion of the capital call.

At step 306, tokens may be redeemed for a dollar amount (e.g., sell their investment in the private fund). For example, the investor, e.g. via the system 100, may for example offer the tokens for sale on the reliance trust business 132. Upon receiving an offer and a corresponding acceptance to purchase one or more tokens through the reliance trust business 132, the reliance trust business 132 may first validate the sale and purchase of the token. Upon receiving the verification, the reliance trust business 132 may send a request to the tokenization platform 102 to update the private blockchain 124. Upon receiving the request, the tokenization platform may (1) mint a set of tokens, the set of tokens being equivalent in amount to the portion of one or more tokens purchased; (2) transfer the set of tokens to the investor who purchased the tokens; and (3) destroy the portion of the one or more tokens belonging to the seller from the platform. This process of minting, transferring, and destroying may for example be recorded in a single block in the private blockchain 124. This may be performed by creating a block in a blockchain as described above.

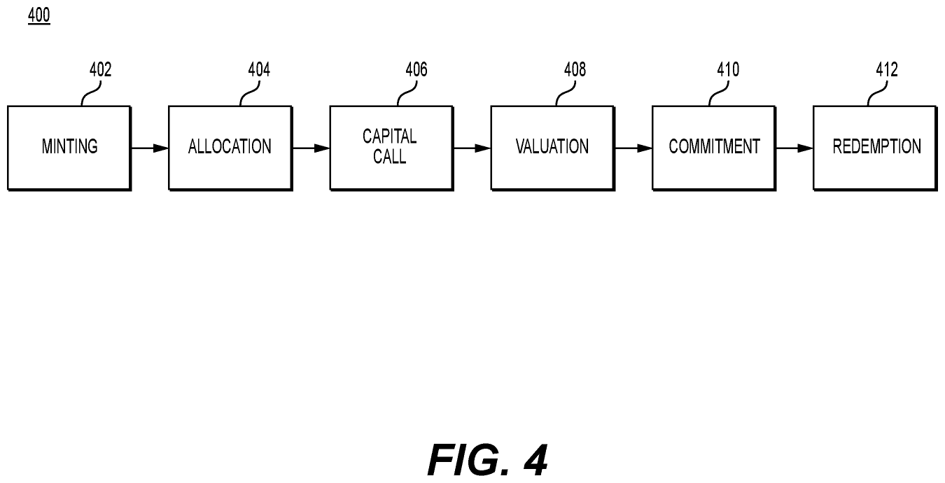

FIG. 4 depicts an exemplary flowchart of the minting, allocation, and redemption of a digital asset, according to one aspect of the present disclosure. The flowchart 400 may depict an exemplary method of an investment journey of a digital assets. Exemplary process flows of the method 400, performed in accordance with the system 100 above, are described hereinafter.

At step 402, a digital token may be minted incorporating the techniques of step 206.

At step 404, a digital token may be allocated incorporating the techniques of step 208.

At step 406, a capital call may be performed incorporating the techniques of step 304.

At step 408, a valuation of the digital token may occur. For example, the digital token may represent the value of a resource source. At periodic internals, the total value of the tokens may be adjusted based on an updated value of the resource source. For example, the tokenization platform 102 or the private capital suite 130 may receive a notification of the increased value of a private fund that has a corresponding digital token. Upon retrieval of this notification, all digital tokens associated with the resource source may be updated. For example, the tokenization platform 102 may automatically generate a block for the private blockchain 124 utilizing the block generating principles described herein.

For example, if a fund previously had 1,000 tokens and a total valuation of the first resource source (e.g., the private fund) at $1,000,000 then the token may have previously been assigned a value of $1,000 each. If the tokenization platform receives notice that the value of the first resource source has been adjusted to $1,200,000, then the tokenization platform may automatically initiate a blockchain entry to update the price of each token to $1,200.

At step 410, which in some cases may take place prior to a capital call at step 406 and before a valuation at step 408, a commitment may remain for a token. A commitment may refer to an amount of capital that an initial investor (e.g., the first investor to receive an allocated token) has agree to contribute to a first resource associated with the digital token. This may for example have been stored in the smart contract associated with the digital token. The commitment may be a legal agreement to contribute additional capital to the first resource (e.g., to a private fund).

A digital token created by the tokenization platform 102 may thus include a commitment as a variable that is stored in the smart contract and stored with each of the created digital tokens.

The tokenization platform 102 may allow for a user to sell a token that still includes a commitment. Thus, a user may sell a token that includes a commitment. If a current holder (e.g., a limited partner) that has at token agree to sell their token to a new investor (e.g., another limited partner) at an agree upon price, then the purchasing investor will be buying the remaining commitment in addition to the share of the fund (e.g., by purchasing the token).

At step 412, redemption of a token may occur. If no commitment remains, then step 410 may utilize the techniques of step 306. In one example, after completion of commitments and a first resource (e.g., a monetary fund) associated with the fund runs the duration, then the tokens may be destroyed (e.g., redeemed) and used for the payout to the investors that own the tokens. Thus, upon completion of the duration of a fund (e.g., as indicated in the smart contract), the tokenization platform 102 may automatically generate a blockchain entry to delete the tokens and administer (e.g., through the reliance trust business 132) a payout equal to the value of the tokens.

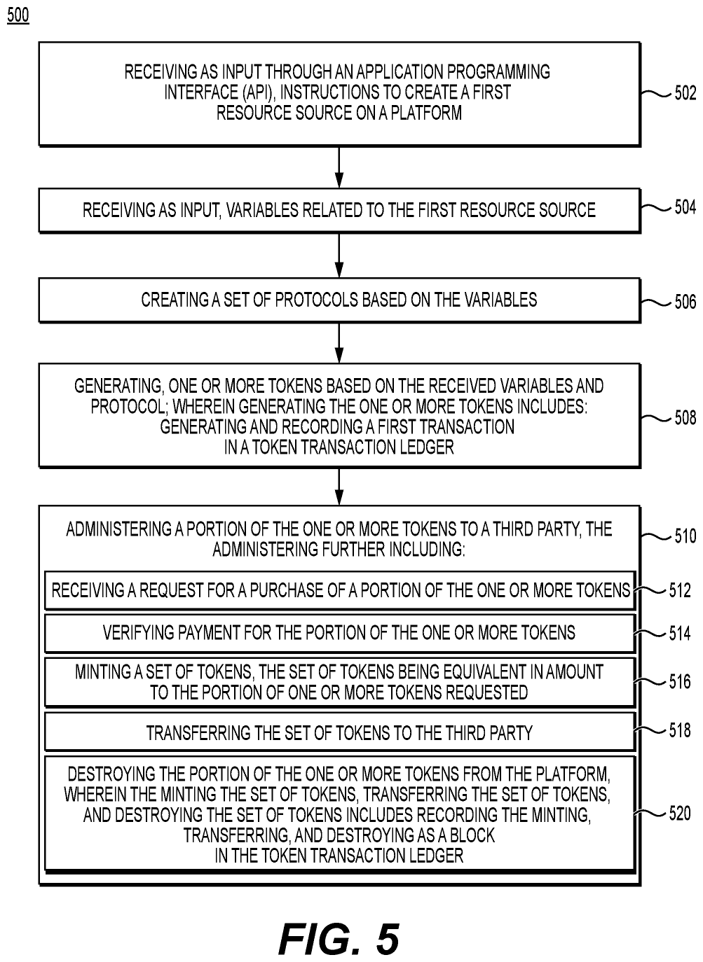

FIG. 5 depicts an exemplary flowchart of a method for creating and administering a security token representing a monetary fund, according to one aspect of the present disclosure.

At step 502, instructions to create a first resource source on a platform may be received as input through an application programming interface (API).

At step 504, variables related to the first resource may be received as input.

At step 506, a set of protocols based on the variables may be created.

At step 508, one or more tokens may be generated based on the received variables and protocol; wherein generating the one or more tokens includes: generating and recording a first transaction in a token transaction ledger.

At step 510, a portion of the one or more tokens may be administered to a third party. Step 510 may include the sub steps 512 through 520. At 512 a request for a purchase of a portion of the one or more tokens may be received. At step 514 payment for the portion of the one or more tokens may be verified. At step 516, a set of tokens may be minted, the set of tokens being equivalent in amount to the portion of the one or more tokens requested. At step 518, the set of tokens may be transferred to the third party. At step 512, the portion of the one or more tokens from the platform may be deleted. Minting the set of tokens, transferring the set of tokens, and destroying the set of tokens includes recording the minting, transferring, and destroying as a block in the token transaction ledger.

FIG. 6 illustrates a computer system for executing the techniques described herein, according to one or more embodiments of the present disclosure. As illustrated in FIG. 6, the computer system 600 may include a processor 602, e.g., a central processing unit (CPU), a graphics processing unit (GPU), or both. The processor 602 may be a component in a variety of systems. For example, the processor 602 may be part of a standard personal computer or a workstation. The processor 602 may be one or more general processors, digital signal processors, application specific integrated circuits, field programmable gate arrays, servers, networks, digital circuits, analog circuits, combinations thereof, or other now known or later developed devices for analyzing and processing data. The processor 602 may implement a software program, such as code generated manually (i.e., programmed).

The computer system 600 may include a memory 604 that can communicate via a bus 608. The memory 604 may be a main memory, a static memory, or a dynamic memory. The memory 604 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 604 includes a cache or random-access memory for the processor 602. In alternative implementations, the memory 604 is separate from the processor 602, such as a cache memory of a processor, the system memory, or other memory. The memory 604 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 604 is operable to store instructions executable by the processor 602. The functions, acts or tasks illustrated in the figures or described herein may be performed by the programmed processor 602 executing the instructions stored in the memory 604. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel payment and the like.

As shown, the computer system 600 may further include a display unit 610, such as a liquid crystal display (LCD), an organic light emitting diode (OLED), a flat panel display, a solid-state display, a cathode ray tube (CRT), a projector, a printer or other now known or later developed display device for outputting determined information. The display 610 may act as an interface for the user to see the functioning of the processor 602, or specifically as an interface with the software stored in the memory 604 or in the drive unit 606.

Additionally or alternatively, the computer system 600 may include an input device 612 configured to allow a user to interact with any of the components of system 600. The input device 612 may be a number pad, a keyboard, or a cursor control device, such as a mouse, or a joystick, touch screen display, remote control, or any other device operative to interact with the computer system 600.

The computer system 600 may also or alternatively include a disk or optical drive unit 606. The disk drive unit 606 may include a computer-readable medium 622 in which one or more sets of instructions 624, e.g., software, can be embedded. Further, the instructions 624 may embody one or more of the methods or logic as described herein. The instructions 624 may reside completely or partially within the memory 604 and/or within the processor 602 during execution by the computer system 600. The memory 604 and the processor 602 also may include computer-readable media as discussed above.

In some systems, a computer-readable medium 622 includes instructions 624 or receives and executes instructions 624 responsive to a propagated signal so that a device connected to a network 670 can communicate voice, video, audio, images, or any other data over the network 670. Further, the instructions 624 may be transmitted or received over the network 670 via a communication port or interface 620, and/or using a bus 608. The communication port or interface 620 may be a part of the processor 602 or may be a separate component. The communication port 620 may be created in software or may be a physical connection in hardware. The communication port 620 may be configured to connect with a network 670, external media, the display 610, or any other components in system 600, or combinations thereof. The connection with the network 670 may be a physical connection, such as a wired Ethernet connection or may be established wirelessly as discussed below. Likewise, the additional connections with other components of the system 600 may be physical connections or may be established wirelessly. The network 670 may alternatively be directly connected to the bus 608.

While the computer-readable medium 622 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 622 may be non-transitory, and may be tangible.

The computer-readable medium 622 can include a solid-state memory such as a memory card or other package that houses one or more non-volatile read-only memories. The computer-readable medium 622 can be a random-access memory or other volatile re-writable memory. Additionally or alternatively, the computer-readable medium 622 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 600 may be connected to one or more networks 670. The network 670 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 670 may include wide area networks (WAN), such as the Internet, local area networks (LAN), campus area networks, metropolitan area networks, a direct connection such as through a Universal Serial Bus (USB) port, or any other networks that may allow for data communication. The network 670 may be configured to couple one computing device to another computing device to enable communication of data between the devices. The network 670 may generally be enabled to employ any form of machine-readable media for communicating information from one device to another. The network 670 may include communication methods by which information may travel between computing devices. The network 670 may be divided into sub-networks. The sub-networks may allow access to all of the other components connected thereto or the sub-networks may restrict access between the components. The network 670 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel payment. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP, etc.) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosed embodiments are not limited to any particular implementation or programming technique and that the disclosed embodiments may be implemented using any appropriate techniques for implementing the functionality described herein. The disclosed embodiments are not limited to any particular programming language or operating system.

It should be appreciated that in the above description of exemplary embodiments, various features of the embodiments are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that a claimed embodiment requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment.

Furthermore, while some embodiments described herein include some but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the function.

In the description provided herein, numerous specific details are set forth. However, it is understood that embodiments of the present disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the present disclosure, those skilled in the art will recognize that other and further modifications may be made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A method for creating and administering a security token representing a resource source, the method comprising:
receiving as input through an application programming interface (API), instructions to create a first resource source on a platform;
receiving as input, variables related to the first resource source;
creating, a set of protocols based on the variables;
generating, one or more tokens based on the received variables and protocol; wherein generating the one or more tokens includes: generating and recording a first transaction in a token transaction ledger; and
administering a portion of the one or more tokens to a third party, the administering further including:
receiving a request for a purchase of a portion of the one or more tokens;
verifying payment for the portion of the one or more tokens;
minting a set of tokens, the set of tokens being equivalent in amount to the portion of the one or more tokens requested;
transferring the set of tokens to the third party; and
destroying the portion of the one or more tokens from the platform,
wherein the minting the set of tokens, transferring the set of tokens, and destroying the set of tokens includes recording the minting, transferring, and destroying as a block in the token transaction ledger.

2. The method of claim 1, wherein the variables related to a fund includes a monetary value of the fund, a number of tokens to create, a name of the fund, and a set of terms and conditions for the fund.

3. The method of claim 2, wherein the one or more token includes a single token for each dollar value of the monetary value of the fund.

4. The method of claim 3, wherein the set of protocols define a smart contract and the smart contract defines a set of terms for the fund.

5. The method of claim 1, further comprising;
transferring accounting records of the one or more tokens to an accounting platform automatically upon the minting, transferring, or destroying of the one or more tokens.

6. The method of claim 1, wherein the amount of the one or more tokens remains the same before and after administering a portion of the one or more tokens to a third party.

7. The method of claim 1, wherein the first transaction includes the variables related to a new monetary fund.

8. The method of claim 1, wherein the first resource source represents a private market fund.

9. The method of claim 1, wherein the one or more tokens includes a commitment variable, wherein the commitment variable corresponds to a legal value owed by the third party of the one or more tokens to the first resource source.

10. The method of claim 1, further including:
receiving a notification to generate a request for capital from the third party owners of the one or more tokens;
upon receiving verification of a payment associated with the request for capital, initiating a new block in the token transaction ledger to update a value of each of the one or more tokens, to include the payment amount.

11. A system for creating and administering a security token representing a resource source, the system comprising:
a memory having processor-readable instructions stored therein; and
at least one processor configured to access the memory and execute the processor-readable instructions to perform operations including:
receiving as input through an application programming interface (API), instructions to create a first resource source on a platform;
receiving as input, variables related to the first resource source;
creating, a set of protocols based on the variables;
generating, one or more tokens based on the received variables and protocol; wherein generating the one or more tokens includes: generating and recording a first transaction in a token transaction ledger; and
administering a portion of the one or more tokens to a third party, the administering further including:
receiving a request for a purchase of a portion of the one or more tokens;
verifying payment for the portion of the one or more tokens;
minting a set of tokens, the set of tokens being equivalent in amount to the portion of the one or more tokens requested;
transferring the set of tokens to the third party; and
destroying the portion of the one or more tokens from the platform,
wherein the minting the set of tokens, transferring the set of tokens, and destroying the set of tokens includes recording the minting, transferring, and destroying as a block in the token transaction ledger.

12. The system of claim 11, wherein the variables related to a fund includes a monetary value of the fund, a number of tokens to create, a name of the fund, and a set of terms and conditions for the fund.

13. The system of claim 12, wherein the one or more token includes a single token for each dollar value of the monetary value of the fund.

14. The system of claim 13, wherein the set of protocols define a smart contract and the smart contract defines a set of terms for the fund.

15. The system of claim 11, further comprising;
transferring accounting records of the one or more tokens to an accounting platform automatically upon the minting, transferring, or destroying of the one or more tokens.

16. The system of claim 11, wherein the amount of the one or more tokens remains the same before and after administering a portion of the one or more tokens to a third party.

17. The system of claim 11, wherein the first transaction includes the variables related to a new monetary fund.

18. The system of claim 11, wherein the one or more tokens includes a commitment variable, wherein the commitment variable corresponds to a legal value owed by the third party of the one or more tokens to the first resource source.

19. The system of claim 11, further including:
receiving a notification to generate a request for capital from the third party owners of the one or more tokens;
upon receiving verification of a payment associated with the request for capital, initiating a new block in the token transaction ledger to update a value of each of the one or more tokens, to include the payment amount.

20. A non-transitory computer readable medium storing processor-readable instructions which, when executed by at least one processor, cause the at least one processor to perform operations including:
receiving as input through an application programming interface (API), instructions to create a first resource source on a platform;
receiving as input, variables related to the first resource source;
creating, a set of protocols based on the variables;
generating, one or more tokens based on the received variables and protocol; wherein generating the one or more tokens includes: generating and recording a first transaction in a token transaction ledger; and
administering a portion of the one or more tokens to a third party, the administering further including:
receiving a request for a purchase of a portion of the one or more tokens;
verifying payment for the portion of the one or more tokens;
minting a set of tokens, the set of tokens being equivalent in amount to the portion of the one or more tokens requested;
transferring the set of tokens to the third party; and
destroying the portion of the one or more tokens from the platform,
wherein the minting the set of tokens, transferring the set of tokens, and destroying the set of tokens includes recording the minting, transferring, and destroying as a block in the token transaction ledger.
